(19) United States
(12) Patent Application Publication
(10) Pub. No.: US 2009/0273539 A1
(43) Pub. Date: Nov. 5, 2009

(54) Computer with Multiple Screens

(76) Inventor: Lisa J. Pruett, Lucas, TX (US)

Correspondence Address: WILSON DANIEL SWAYZE, JR., 3804 CLEARWATER CT., PLANO, TX, 75025, US

(21) Appl. No.: 12/114,527

(22) Filed: May 2, 2008

(51) Int. Cl. G09G 5/00

(52) U.S. Cl. 345/1.1

(57) ABSTRACT

A laptop computer, notebook or personal computer may include a base member including computer electronics, a first screen positioned substantially over the base member and electrically connected to the base member, and a second screen extending substantially vertically from the first screen and electrically connected to the base member. The second screen may pivot with respect to the first screen, and the second screen may pivot behind the first screen. The second screen may move on tracks to extend and retract the second screen, and an arm may connect the base member and the second screen. The first screen and the second screen may be substantially centered with respect to the base member, and the laptop computer may include a third screen which substantially horizontally extends from the first screen. The second screen may extend substantially vertically from the first screen.

### FIELD OF THE INVENTION

The present invention relates to computer display screens. More specifically, the invention relates to a screen for laptop, notebook and personal computers that allows multiple computer displays so that more information can be compared and contrasted by the user.

### DESCRIPTION OF THE RELATED ART

Laptop and notebook computers allow a user to work in virtually any locale while personal computers are more powerful and do not have battery limitations. Wireless communication systems enable workers to send information from a notebook computer or laptop computer to the office, and receive other information in return. Many people therefore work on notebook computers or laptop computer while on public transportation, in coffee shops, or even while waiting in the doctor's office.

A computer will generally display a single page of the document at one particular instance or at most, a portion of two pages at one particular instance. This is generally unsatisfactory because information that is going into a document may come from another source or multiple sources. Presently, in order to obtain additional information, it is necessary to access a different page. Because of the single screen, this different page must be displayed while the original page is not being displayed. It may be necessary to transfer this additional information back to the original page for example by cut-and-paste; in which case, it is necessary to redisplay the original page. If a great deal of information is to be transferred, this process is cumbersome. It would be extremely helpful if multiple pages could be so simultaneously displayed.

The display screens of the laptop computer typically utilize a relatively low-powered liquid crystal display (LCD) to reduce power consumption and prolong battery life. Although LCD screens are more efficient, they also produce lower intensity images that are less visible than those of their desktop computer counterparts. Other laptop computers may utilize plasma screens.

As the advent of the computer age has changed into the computer revolution, constant improvements in the computer field are being sought out. Because more and more people are spending more time sitting in front of a computer monitor, improvements are necessary to enhance the user's ability to view the monitor with as few distractions as possible.

U.S. Pat. No. 7,134,758 discloses a privacy screen for laptop computer is an expandable hood that may be removably attached to a notebook computer. The privacy screen has an elastic fabric cover secured around an expandable frame. The frame has a plurality of telescoping rods attached to connector pieces using ball and socket joints, which allow the frame to expand concurrently in multiple directions. The screen may be assembled before sale, in which case the screen uses a fixed number of pieces in its frame and the fabric cover is permanently secured to the frame, or provided as a kit, in which cut-out sections of the fabric cover allow the end user to assemble the telescoping rods and connecting pieces as desired. The frame may be secured to the laptop using spring-biased clips.

### SUMMARY

A laptop computer or personal computer may include a base member including computer electronics, a first screen positioned substantially over the base member and electrically connected to the base member, and a second screen extending from the first screen and electrically connected to the base member.

The second screen may pivot with respect to the first screen, and the second screen may pivot behind the first screen.

The second screen may move on tracks to extend and retract the second screen, and an arm may connect the base member and the second screen.

The first screen and the second screen may be substantially centered with respect to the base member, and the laptop computer may include a third screen which substantially horizontally extends from the first screen.

The second screen may extend substantially vertically from the first screen.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a laptop computer with a first pivoting screen and a second screen;

FIG. 2 illustrates another embodiment of the laptop computer with the first pivoting screen and the second screen;

FIG. 3 illustrates another embodiment of the laptop computer with the first pivoting screen and the second screen;

FIG. 4 illustrates a personal computer with the first screen and a second screen;

FIG. 5 illustrates in another embodiment of the personal computer with the first screen and the second screen;

FIG. 6 illustrates another embodiment of the personal computer with the first screen and second screen;

FIG. 7 illustrates another embodiment of the laptop computer with the first pivoting screen, the second screen and a third screen;

FIG. 8 illustrates another embodiment of the personal computer showing the first screen, the second screen and the third screen;

FIG. 9 illustrates another embodiment of the laptop computer showing the first screen and the second screen;

FIG. 10 illustrates another embodiment of the personal computer showing the first screen and the second screen;

FIG. 11 illustrates a side view of a laptop computer.

### DETAILED DESCRIPTION

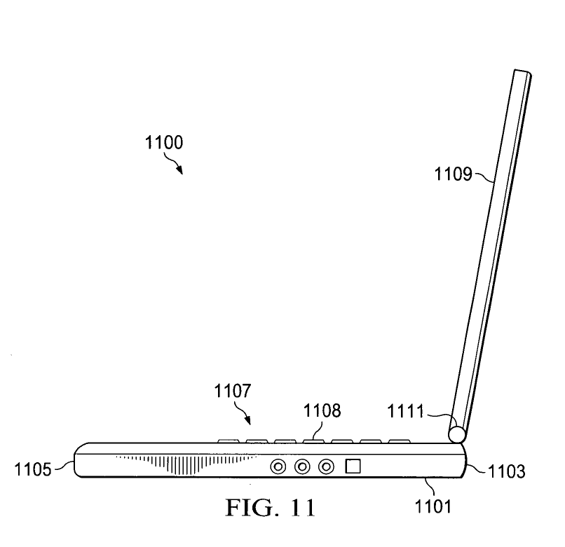

According to the present invention and as shown in FIG. 11, a laptop computer 1100 is provided which has a base member 1101, having computer electronics therein, a front portion 1105 and a rear portion 1103. A display screen 1109 is provided mounted on a display screen mounting mechanism 1111 for pivotal movement between a closed position and an open position, with the display screen 1109 adjacent to the rear portion 1103 of the base member 1101. The display screen mounting mechanism 1111 includes a structure to permit pivotal movement of the screen in the open position. The laptop computer 1100 may mean a notebook, PDA or other such device.

A keyboard assembly 1107 having keys 1108 is provided having a front end and a rear end and mounted on the base member 1101 for movement between a retracted position and an extended position or detect the finger position.

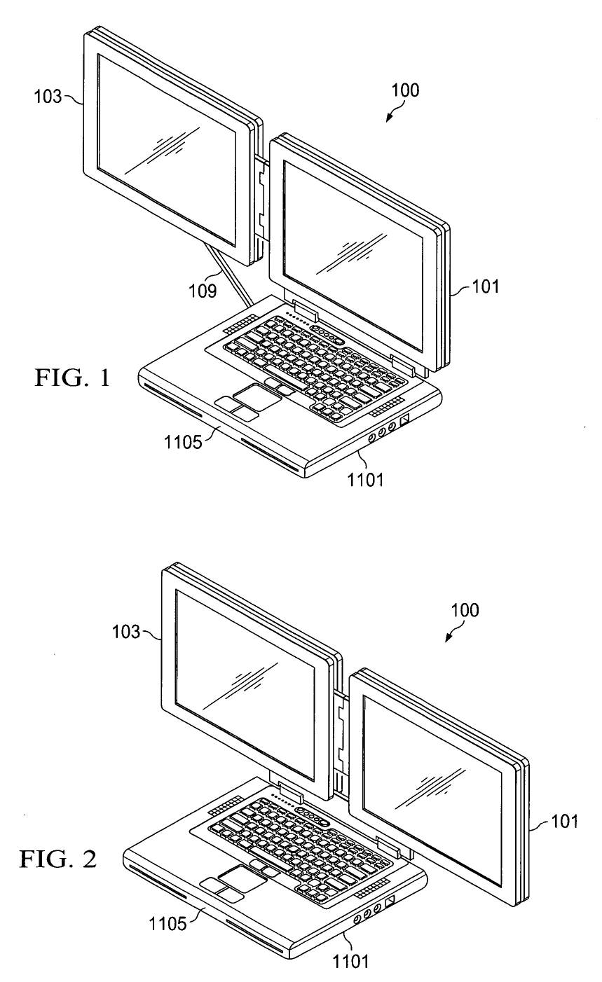

FIG. 1 illustrates a lap top computer 100 in accordance with the teachings of the present invention. FIG. 1 illustrates a first pivotable screen 101 which is positioned substantially over the base member 1101, and the first pivotable screen 101 pivots between an open and closed position. FIG. 1 additionally illustrates a second extendable screen 103 which is electrically connected to the base member 1101 and substantially horizontally extends from the first pivoting screen 101. The second extendable screen 103 may pivot to an open position and a closed position behind or in front of a first pivoting screen 101. The second extendable screen 103 may be connected to the first pivoting screen 101 by a pivoting apparatus such as hinges or other appropriate device. Alternatively, the second extendable screen 103 may move within a guide track on a frame or hinges formed on the first pivoting screen 101 to move the second extendable screen 103 between the open and the closed position. FIG. 1 additionally illustrates that the second extendable screen 103 may be supported by arm 109 which extends from the base member 1101 to the second extendable screen 103. The teachings of the present invention can be extended to a third screen or more and can be assembled to form the laptop, note book, PDA or personal computer as a kit or system.

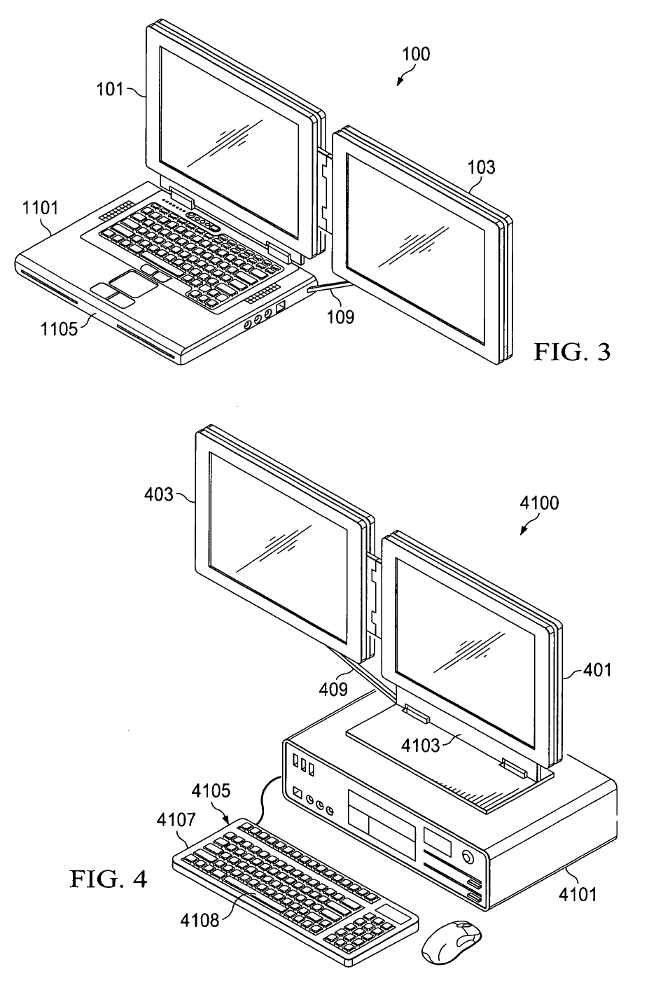

FIG. 2 illustrates that the first pivoting screen 101 and the second extendable screen 103 has been positioned at substantially the center of the base member 1101. Both the first pivoting screen 101 and the second extendable screen 103 are electrically connected to the base member 1101.

FIG. 3 illustrates that the second extendable screen 103 substantially horizontally or substantially parallel in the opposing direction with respect to FIG. 1. Both the first pivoting screen 101 and the second extendable screen 103 are electrically connected to the base member 1101. FIG. 3 illustrates a first pivoting screen 101 which is positioned substantially over the base member 1101, and the first pivoting screen 101 pivots between an open and closed position. FIG. 3 additionally illustrates a second extendable screen 103 which is electrically connected to the base member 1101 and extends from the first pivoting screen 101. The second extendable screen 103 may pivot to an open position and a close position behind the first pivoting screen 101. The second extendable screen 103 may be connected to the first pivoting screen 101 by a pivoting apparatus such as hinges or other appropriate device. Alternatively, the second extendable screen 103 may move within a guide track or channel formed on the first pivoting screen 101 to move the second extendable screen 103 between the open and the closed position. FIG. 3 additionally illustrates that the second extendable screen 103 may be supported by arm 109 which extends from the base member 1101 to the second extendable screen 103.

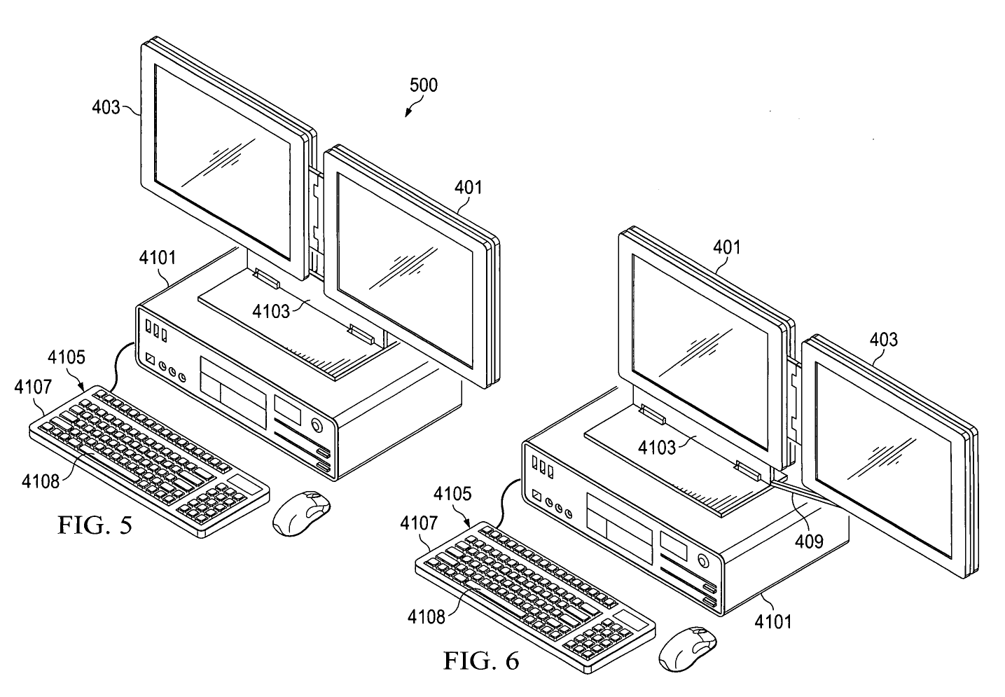

According to the present invention and as shown in FIGS. 4-6, a personal computer 4100 is provided which has a personal computer base member 4101 and which has computer electronics therein. A detachable keyboard 4105 may be connected to the personal computer base member 4101. A display screen 401 is provided mounted on a personal computer display screen mounting mechanism 4103 for pivotal movement. The display screen mounting mechanism 4103 includes a structure to permit pivotal movement of the screen.

The detachable keyboard 4105 includes a keyboard assembly 4107 having keys 4108 is provided on the detachable keyboard 4105.

FIG. 4 illustrates a personal computer 4100 in accordance with the teachings of the present invention. FIG. 4 illustrates a first screen 401 which is positioned substantially over the computer display screen mounting mechanism 4103. FIG. 4 additionally illustrates a second extendable screen 403 which is electrically connected to the personal computer base member 4101 and substantially horizontally extends from the first screen 401. The second extendable screen 403 may pivot to an open position and a close position behind or in front of the first screen 401. The second extendable screen 403 may be connected to the first screen 401 by a pivoting apparatus such as hinges or other appropriate device. Alternatively, the second extendable screen 403 may move within a guide track or frame or hinge formed on the first screen 401 to move the second extendable screen 403 between the open and the closed position. FIG. 4 additionally illustrates that the second extendable screen 103 may be supported by arm 409 which extends from the computer display screen mounting mechanism 4103 to the second extendable screen 103.

FIG. 5 illustrates that the first screen 401 and the second extendable screen 403 has been positioned at substantially the center of the computer display screen mounting mechanism 4103. Both the first screen 401 and the second extendable screen 403 are electrically connected to the personal computer base member 4101.

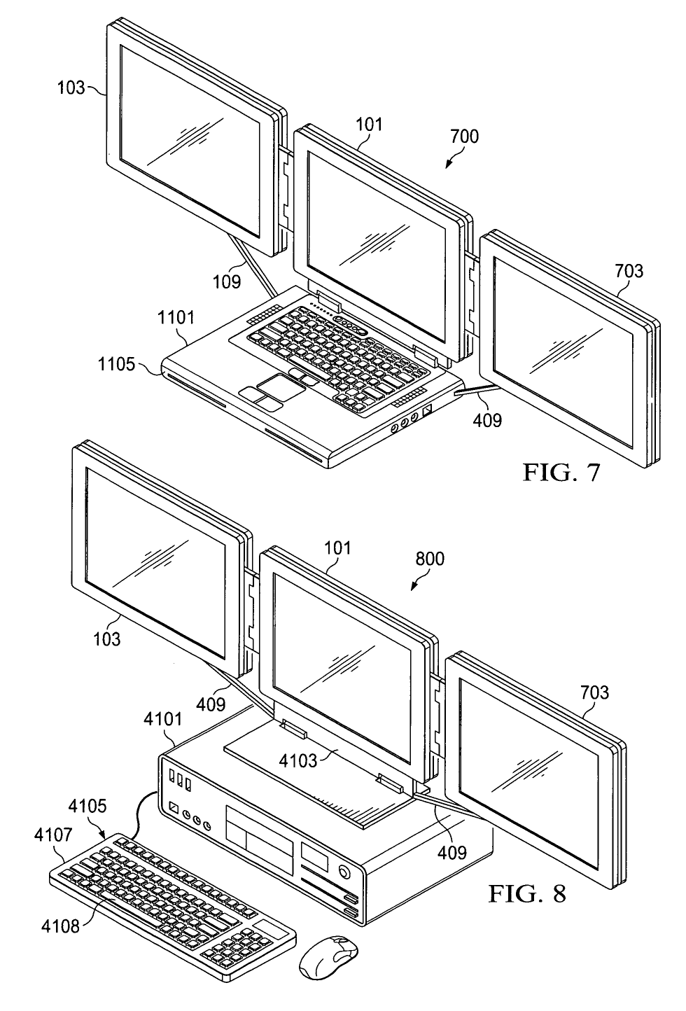

FIG. 6 illustrates that the second extendable screen 403 extends in the opposing direction with respect to FIG. 4. Both the first screen 401 and the second extendable screen 403 are electrically connected to the personal computer base member 4101. FIG. 6 illustrates a first screen 401 which is positioned substantially over the computer display screen mounting mechanism 4103. FIG. 6 additionally illustrates a second extendable screen 403 which is electrically connected to the base member 1101 and substantially horizontally extends from the first screen 401. The second extendable screen 403 may pivot to an open position and a closed position behind the first screen 401. The second extendable screen 403 may be connected to the first pivoting screen 101 by a pivoting apparatus such as hinges or other appropriate device. Alternatively, the second extendable screen 403 may move within a guide track or channel formed on the first screen 401 to move the second extendable screen 403 between the open and the closed position. FIG. 6 additionally illustrates that the second extendable screen 103 may be supported by arm 409 which extends from the computer display screen mounting mechanism 1103 to the second extendable screen 103.

FIG. 7 illustrates a lap top computer 700 in accordance with the teachings of the present invention. FIG. 7 illustrates a first pivotable screen 101 which is positioned substantially over the base member 1101, and the first pivotable screen 101 pivots between an open and closed position. FIG. 7 additionally illustrates a second extendable screen 103 which is electrically connected to the base member 1101 and substantially horizontally extends from the first pivoting screen 101. The second extendable screen 103 may pivot to an open position and a closed position behind a first pivoting screen 101. The second extendable screen 103 may be connected to the first pivoting screen 101 by a pivoting apparatus such as hinges or other appropriate device. Alternatively, the second extendable screen 103 may move within a guide track formed on the first pivoting screen 101 to move the second extendable screen 103 between the open and the closed position. FIG. 7 additionally illustrates a third extendable screen 703 which is electrically connected to the base member 1101 and substantially horizontally extends from the first pivoting screen 101. The third extendable screen 703 may pivot to an open position and a closed position behind a first pivoting screen 101. The third extendable screen 703 may be connected to the first pivoting screen 101 by a pivoting apparatus such as hinges were other appropriate device. Alternatively, the third extendable screen 703 may move within a guide track formed on the first pivoting screen 101 to move the third extendable screen 703 between the open and the closed position.

FIG. 8 illustrates a personal computer 800 in accordance with the teachings of the present invention. FIG. 8 illustrates a first screen 101 which is positioned substantially over the personal computer base member 4101. FIG. 7 additionally illustrates a second extendable screen 103 which is electrically connected to the personal computer base member 4101 and substantially horizontally extends from the first screen 101. The second extendable screen 103 may pivot to an open position and a closed position behind a first pivoting screen 101. The second extendable screen 103 may be connected to the first pivoting screen 101 by a pivoting apparatus such as hinges or other appropriate device. Alternatively, the second extendable screen 103 may move within a guide track formed on the first screen 101 to move the second extendable screen 103 between the open and the closed position.

FIG. 8 additionally illustrates a third extendable screen 703 which is electrically connected to the base member 1101 and substantially horizontally extends from the first screen 101. The third extendable screen 703 may pivot to an open position and a closed position behind a first screen 101. The third extendable screen 703 may be connected to the first screen 101 by a pivoting apparatus such as hinges or other appropriate device. Alternatively, the third extendable screen 703 may move within a guide track formed on the first screen 101 to move the third extendable screen 703 between the open and the closed position.

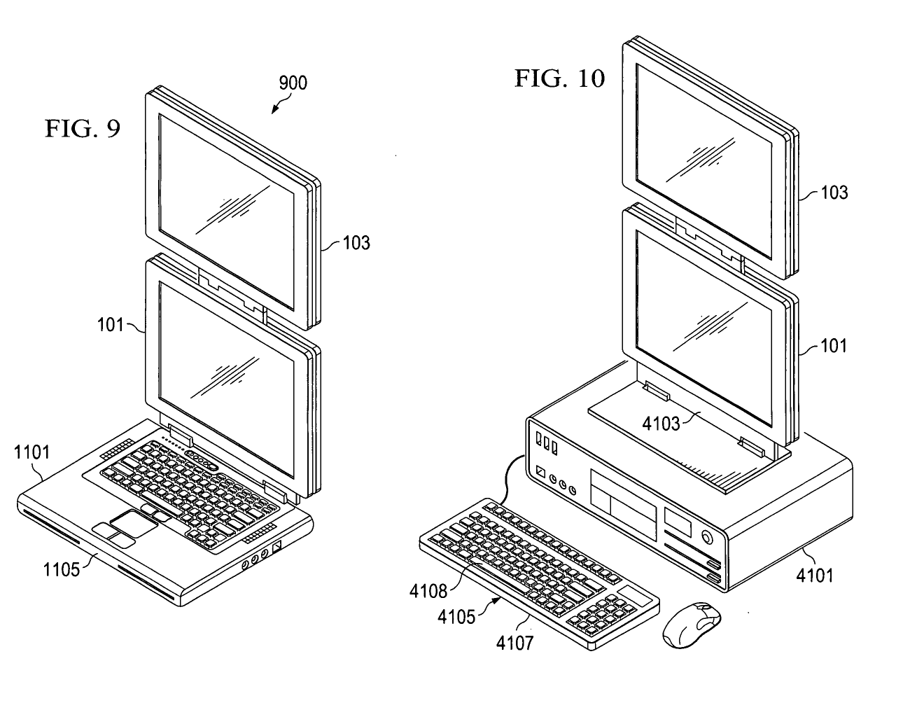

FIG. 9 illustrates a lap top computer 100 in accordance with the teachings of the present invention. FIG. 9 illustrates a first pivotable screen 101 which is positioned substantially over the base member 1101, and the first pivotable screen 101 pivots between an open and closed position. FIG. 9 additionally illustrates a second extendable screen 103 which is electrically connected to the base member 1101 and substantially vertically extends from the first pivoting screen 101. The second extendable screen 103 may pivot to an open position and a closed position behind a first pivoting screen 101. The second extendable screen 103 may be connected to the first pivoting screen 101 by a pivoting apparatus such as hinges or other appropriate device. Alternatively, the second extendable screen 103 may move within a guide track formed on the first pivoting screen 101 to move the second extendable screen 103 between the open and the closed position.

FIG. 10 illustrates a personal computer 100 in accordance with the teachings of the present invention. FIG. 10 illustrates a first screen 101 which is positioned substantially over the personal computer base member 4101. FIG. 10 additionally illustrates a second extendable screen 103 which is electrically connected to the personal computer base member 4101 and substantially vertically extends from the first screen 101. The second extendable screen 103 may pivot to an open position and a closed position behind the first screen 101. The second extendable screen 103 may be connected to the first screen 101 by a pivoting apparatus such as hinges or other appropriate device. Alternatively, the second extendable screen 103 may move within a guide track formed on the first screen 101 to move the second extendable screen 103 between the open and the closed position.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A laptop computer, comprising:
a base member including computer electronics;
a first screen positioned substantially over the base member and electrically connected to the base member;
a second screen extending from the first screen and electrically connected to the base member.

2. A laptop computer as in claim 1, wherein the second screen pivots with respect to the first screen.

3. A laptop computer as in claim 2, wherein the second screen pivots behind the first screen.

4. A laptop computer as in claim 1, wherein the second screen moves on tracks to extend and retract the second screen.

5. A laptop computer as in claim 1, wherein an arm connects the base member and the second screen.

6. A laptop computer as in claim 1, wherein the first screen and the second screen are substantially centered with respect to the base member.

7. A laptop computer as in claim 1, wherein the laptop computer includes a third screen which substantially horizontally extends from the first screen.

8. A laptop computer as in claim 1, wherein the second screen extends substantially vertically from the first screen.

9. A personal computer, comprising:
a personal computer base member including computer electronics;
a first screen positioned substantially over the personal computer base member and electrically connected to the personal computer base member;
a second screen extending from the first screen and electrically connected to the personal computer base member.

10. A personal computer as in claim 9, wherein the second screen pivots with respect to the first screen.

11. A personal computer as in claim 10, wherein the second screen pivots behind the first screen.

12. A personal computer as in claim 9, wherein the second screen moves on tracks to extend and retract the second screen.

13. A personal computer as in claim 9, wherein an arm connects the personal computer base member and the second screen.

14. A personal computer as in claim 9, wherein the first screen and the second screen are substantially centered with respect to the personal computer base member.

15. A personal computer as in claim 9, wherein the laptop computer includes a third screen which substantially horizontally extends from the first screen.

16. A personal computer as in claim 9, wherein the second screen extends substantially vertically from the first screen.
